(19) United States
(12) Patent Application Publication
(10) Pub. No.: US 2012/0038701 A1
(43) Pub. Date: Feb. 16, 2012

(54) METHOD FOR THE COLOUR-IMPARTING INSCRIBING OF SURFACES

(76) Inventors: Thomas Schalkhammer, Kasten (AT); Roland Palkovits, Wiener Neustadt (AT); Andreas Kornherr, Wien (AT)

(21) Appl. No.: 13/141,434

(22) PCT Filed: Dec. 21, 2009
(86) PCT No.: PCT/EP09/09175

§ 371 Date: Sep. 15, 2011

(30) Foreign Application Priority Data
Dec. 22, 2008 (EP) 08 022 228.4
Jun. 17, 2009 (EP) 09 007 912.0

(51) Int. Cl. B41J 2/015

(52) U.S. Cl. 347/20

(57) ABSTRACT

The invention relates to a reactive ink-jet printing method for implementation on substrates such as paper, board, corrugated cardboard, films, injection or compression moulded plastics parts, metal, ceramic surfaces, paint coats or corrosion protection layers, characterized in that the substrates are coated with a polyphenol, and a reactive ink composed of at least one dissolved metal salt selected from the group consisting of the compounds of iron, molybdenum, tungsten and titanium is reacted by ink-jet printing on or in the surface of the stated substrates, to form a stable colour complex which is immediately perceptible to the human eye, and the invention also relates to suitable coated materials and to a writing system for the implementation of the method.

The invention relates to a novel method for color-imparting inscription of surfaces. The invention describes a reactive method of coloration, which can be used for inkjet printing and consists of at least two unmixed components—one on or in the material to be inscribed and one in the printer or in its stock reservoir tank, which for inscription purposes is inkjetted onto the material to be inscribed and reacts by color changing especially color deepening.

### PRIOR ART

Known are reactive inks (GB1469437, 1977-04-06, OZALID CO LTD; LANDAU R of Ink OZALID CO Ltd), which on application to an alkaline surface provide a colored printout from a precursor. An aqueous solution contains a chelate of iron or of titanium, a polyhydroxy compound (tannin, pyrocatechol, pyrogallol, gallic acid or water-soluble derivatives), ascorbic acid and the sodium salt of chromotropic acid. A typical ink contains water, iron ammonium oxalate, iron EDTA, titanium potassium oxalate, oxalic acid, citric acid, tannin, the sodium salt of chromotropic acid, pyrogallol, ascorbic acid, pyrocatechol, ethylene glycol and sorbitol.

Known are invisible inks (GB1292831, 1972-10-11, MEREDITH CORP (US) and FR2028486 (A1) and DE1946393 (A1)) with a phenolic or enolic group which reacts with an oxidizing ion of a metal to achieve the formation of a color. Admixed are a binder and a carrier solvent). The reactive component is, for example, gallic acid, propyl gallate, acetoacetate, phenol, resorcinol, cresol, vanillin, guaiacol or zinc resorcinate. The developers used are iron salts, oxidizing salts of metals, citric acid or lead ions and Congo Red or xylenol orange. The binders used are polyvinylpyrrolidone, cellulose hydroxypropoxy ether or polyamide. Carriers are glycols, glycol ethers, esters and ether alcohols. Optional additives are fluorophores e.g. methyl umbelliferone, citric acid, fillers e.g. silica or silicates, antioxidants and UV stabilizers e.g. 2,4-dihydroxybenzophenone.

Also known are other invisible inks e.g. (GB1350930, 1974-04-24, DICK CO AB also NL7103180 (A), FR2084649 (A5), DE2112380 (A1) from A B DICK CO) which in addition to gallic acid contain leuco dyes for example. Known are heat-sensitive inks (JP2265978, 1990-10-30, MATSUSHITA TOSHIHIKO; MORISHITA SADAO, MITSUBISHI PAPER MILLS LTD) using an aromatic isocyanate component, an imino component, an organic solvent and gallotannin or methyl gallates, ether gallates, trimethoxygallates or gallius acid 3-methyl ether.

Known are recording inks (JP58183769, 1983-10-27, AKUTSU HIDEKAZU; FUJII TADASHI; MURAKAMI KAKUJI; ARIGA TAMOTSU; KAZAMI TAKEO of RICOH KK) of an N-alkanolamine salt of m-digallic acid to enhance the water fastness of a colored material without changing the solubility of the dye.

Known are inks wherein phenolic components (preferably gallic acid and pyrogallol) are contained (JP57207659, 1982-12-20, OOWATARI AKIO, of EPSON CORP) to provide the print with rapid drying and not to clog the printer nozzle and free of dissolved oxygen with a pH of 12-14. Also known is a colored ink (JP9059547, 1997-03-04, KAWASHIMA SEIJI) which uses a colorless ink consisting of e.g. zinc chloride, salicylic acid, tannin or the like with a colorant as electron-donating component and the color is decolorized by addition of water. Known are inkjet inks consisting of the tannin from persimmon (KR20040012361, 2004-02-11, SON GYU, YOUNGDONG AGRICLTUVAL) as replacement for customary tannin, with reduced production costs and a secure supply position. The ink contains various components including water, organic solvents, dyes, tannin, extract from persimmon containing gallic acid, ellagic acid and catechin.

Known is an inkjet ink said to prevent the clogging of nozzles (JP2005272762, 2005-10-06, KONO MONICHIRO; IIDA YASUHARU of TOYO INK MFG CO).

The ink contains 0.3-10 wt. % of food color, 45-98.7 wt. % of ethanol, 0.5-5 wt. % of tannin, 0-30 wt. % of propylene glycol, 0.5-5 wt. % of sodium lactate and 0-5 wt. % of water.

Known is a recording material for inks (JP1241487, 1989-09-26, HAYAMA KAZUHIDE; YAMASHITA AKIRA of MITSUBISHI PETROCHEMICAL CO) which contains 0.1 to 30% of a component having a phenolic OH group, and also a binder of 5-95 wt. % of polyvinyl alcohol and 95-5 wt. % of a cationic water-soluble resin.

The phenolic component has at least two hydroxyl groups and consists of hydroquinone, tannin, resorcinol, di-t-butylphenol, phloroglucinol or bis(4-hydroxyphenol)-methane.

Known is a color-reactive typing paper (GB856188, 1960-12-14, NEALE DAVID JOHN of CARIBONUM LTD) using a colorless “inked ribbon” and an impregnated paper primarily with molybdates and tungstates.

Known is an inkjet paper (JP57087987, 1982-06-01, MURAKAMI MUTSUAKI; SEKIGUCHI YUMIKO of MATSUSHITA ELECTRIC IND CO LTD) with improved light stability on wood-free paper through metallic oxides and the like e.g. tungsten phosphate, metallic chlorides (e.g.: chromium chloride) and or tannin with PVA binder and a white filler (e.g. calcium carbonate etc.).

Known is a copier system (GB191016515, 1911-06-08, CAMERON DUNCAN) using moist tannin- or gallic acid-impregnated paper for making copies of texts written in iron gall ink. Sodium sulfite, borax and phenol serve as additions.

Known is a copier process (GB943401, Feb. 11, 1959, IMAGIC PROCESS Ltd, also NL267030 (A), NL248292 (A), GB991599 (A), BE595169 (A), DE1269630 (B1) using iron sulfate or chromates as developers and polyphenol, pyrogallic acid or tannin.

Known is a thermal method of recording (JP4307289, 1992-10-29, MORITA YASUYOSHI; MURATA TATSUYA; KOYABU KYOKO of OJI PAPER CO) with a two-layered construction wherein one layer contains an iron salt of a fatty acid and a gallic acid derivative and the second layer contains an electron donor color precursor.

Known is a pressure-sensitive recording layer (JP1271284, 1989-10-30, TAJIRI MASANAO; SHINKOU KAZUYUKI; SHIOI SHUNSUKE of KANZAKI PAPER MFG CO LTD) using microencapsulated reactants: 1.) electron-transferring color former 2.) ligand with phenolic OH groups (e.g. gallates, salicylic acid, . . . ) and 3.) desensitizer with 4.) an iron(III) coating layer.

Known is a thermal method of recording (JP60083886, 1985-05-13, MATSUSHITA TOSHIHIKO; MORISHITA SADAO of MITSUBISHI PAPER MILLS LTD) with a layer of alkyl gallates with a melting point of 60-180° C. and a receiving layer consisting of iron salts (preferably as dispersion of iron stearate).

Known is an analogous thermal method of recording (JP60083885, 1985-05-13, MATSUSHITA TOSHIHIKO; MORISHITA SADAO of MITSUBISHI PAPER MILLS LTD) or JP60063192 (1985-04-11, MATSUSHITA TOSHIHIKO; MORISHITA SADAO of MITSUBISHI PAPER MILLS LTD).

Known is an improved writing paper and the ink (GB189724560, 1897-12-11, COX FRED (DE); KORNACHER FRITZ (DE); BRUMM MARCUS (DE)) wherein the script only forms on contact with the paper and the paper has been impregnated with a solution of gallic acid or tannin and is then inscribed with a reactive ink consisting of iron sulfate.

Known is a process for writing and printing (GB280088, 1927-11-10, UBALDO ALEJANDRO D INZEO) for a paper to be impregnated with an aqueous or alcoholic solution of gallic acid or tannin and then inscribed with a reactive ink consisting of iron nitrate or a chromate in a solvent.

Known is a process for writing and printing (DE2505077, 1976-08-19, KRUEGER ELLEN from PELIKAN WERKE WAGNER GUENTHER) wherein a color reaction writing and printing liquid producing a colored script on the basis of the color-forming reaction between gallic acid and heavy metal salts such as iron and vanadium salts, characterized in that a mixture of about 30-200 of gallic acid and about 70-80% of alkali metal gallate is present in the writing liquid, is disclosed. More particularly, the mixture is admixed with alkali metal hydroxide or amine base, converting about 30-20% of the gallic acid into the alkali metal salt or the amine salt, respectively. The invention discloses the production of colorless marks which are only subsequently reacted with the metal salt, and describes the production of these colorless marks in use examples.

As carrier material there come into consideration paper, paperboard, corrugated fiberboards, pigment particles, film, injection- or compression-molded plastics parts, metal, ceramic surfaces, paint layers or corrosion control layers.

Metal-phenol complexes are used in many sectors ranging from inks, printing methods and dyeing methods to use as hair colorants (e.g. JP61056119).

Iron gall ink (or gall ink for short) is an indelible black ink which has been customary since the 3rd Century BCE and with the writability of which with steel nibs is good, but with fountain pens is poor (risk of cloggage). Iron gall ink (consisting of iron sulfate, gall apple extract, gum arabic and so on) has the best flow properties of all inks, has an extremely long nib life and is very lightfast. It has a gray color on application to the paper and only assumes its jet black coloration after some hours, through oxidation. Iron gall ink is only suitable for steel nibs but because of its high acidity not for many fountain pens. It was formed from iron(II) sulfate (iron vitriol), gall apples, water and gum arabic in the Middle Ages. Dried gall apples were mashed up and boiled to form gallic acid (tannin). The iron sulfate and gum arabic were added thereto. Gum arabic serves to improve writability and prevent flocking. By keeping its container airtight the ink can be additionally preserved and protected from flocking.

The final ink is only formed on the paper through oxidation of the ferrous iron with atmospheric oxygen to form ferric ion, which forms a jet black complex with the gallic acid. This takes a day or so. To make the ink more visible at the time of writing, it is further mixed with a dye such as methylene blue which fades later. This was exploited as a style element with some contract inks. The inks are initially blackish blue and dry more or less black.

But iron gall ink itself can fade over the years under unfavorable conditions. Faded iron gall scripts can be made visible again with a solution of potassium hexacyanoferrate(II) with excess hydrochloric acid.

These contract (and partly also registrars' inks) are also customary for fountain pens up to the 1960s, at least in the business sector. Since the use of iron gall inks in fountain pens risked cloggage owing to the oxidation of the starting material for the dye taking place there as well, such inks were associated with some care having to be exercised for the fountain pens. In addition to iron gall inks according to ancient recipes, which are not suitable for fountain pens, there are only very few makers of such an ink for fountain pens. The best known is the fountain pen producer Montblanc, whose own bluish black ink still contains iron gall ink. The bluish black ink from Lamy for example is an ink containing iron gall. In addition, Diamine also offers a bluish black “Registrars Ink”. This is likewise fountain pen capable. Inks in ink cartridges are comparatively rarely iron gall inks, since the regular rinsing required is somewhat more difficult here. The bluish black ink from Montblanc and Lamy is only iron gall containing from the bottle.

Iron inks are preferred in high-value applications such as documents in particular. Important state treaties always have to be written in permanent iron gall ink. Official regulations for document inks are as follows: one liter shall contain at least 27 g of tannic acid and gallic acid and also at least 4 g of metallic iron. The maximum iron content must not be more than 6 g/l for the above amounts. The ink shall be free of leafing, wall coating or sediment after 14 days in the bottle. Eight-day-old writing shall remain very dark after washing with water and alcohol.

The ink shall flow easily and must not be tacky even immediately after drying. Iron gall inks are deemed (provided the official regulations are met) as fit for documentation purposes. In order that this condition is reliably fulfilled, fresh strokes should not be “blotted off” since this withdraws ink from the paper.

Conventional color-imparting inscriptions of materials are usually done by printing, for example using flexographic, offset or gravure printing appliances for usually high-volume applications or via printers (usually, as will be known, inkjet printers and laser printers) or for low-volume applications on site, and/or for printing of goods as thermal printers with thermal paper, thermal labels or thermally sensitive layers on packaging. For this, the printer is equipped with printing ink and/or toner cartridges, the pigment compositions present therein are deposited by the printing operation on the material to be printed, or a pigment which has already been applied to the surface is made to undergo a change in color via heating.

### Problem Addressed by Invention

The problem addressed by the invention was that of providing a novel method wherein the color is formed by a reaction between two components without use of toner pigment-containing printing media.

The problem addressed by the invention was further that of providing a method for producing such coated materials.

The problem addressed by the invention was further that of providing a device whereby the materials of the invention can be provided with the appropriate information items.

### SUMMARY OF INVENTION

The invention accordingly provides a reactive inkjet printing method for practice on substrates such as paper, paperboard, corrugated fiberboards, film, injection- or compression-molded plastics parts, metal, ceramic surfaces, paint layers or corrosion control layers, characterized in that the substrates are coated with a polyphenol and a reactive ink consisting of at least one dissolved metal salt selected from the group of compounds of iron, molybdenum, tungsten, copper and titanium is made to react on or in the surface of said substrates by inkjet printing to form a colored complex that is stable and immediately perceivable by the human eye.

The chemical reaction of the printing liquid and a coating makes the object to be printed undergo a color change in a spatially defined and structured manner wherein any desired characters, letters, character chains, patterns, lines, images, symbols, designs or graphic information become visible through a reaction of the two components.

The invention is based on providing an indelible printing ink which makes objects and materials chemo-reactively writable by reaction of a metal salt and a polyphenol. Generating the colored particles of pigment by chemical transformation produces in situ a usually dark hue after reaction of a colorless or weakly colored layer of precursor compounds. Molybdenum, tungsten and titanium compounds are usually colorless, iron(II) salts are often light green, and iron(III) salts from white to deep brown. An example which may be mentioned here is the transformation of iron(II) sulfate inkjet ink (light yellow) on a gallic acid-coated paper (colorless) to form a black ink.

In contradistinction to a laser print or inkjet print or similar printing methods, the color here is only formed in situ, on and/or within the surface of the object to be inscribed. This provides high colorfastness, high color stability and color formation “in the interior of the object” protected from environmental effects. The advantages can be summarized as follows:
stable color for years (no fading as with thermal papers)
high contrast (unlike most thermal papers)
no complex organically reactive color components of high allergenic potential
almost pure black achievable (as with carbon black-based laser toners)
visible and invisible elements combinable
efficiently machine-readable through high contrast (scanner checkouts, . . . )
extreme thermal stability (no change due to hot atmospheric conditions, . . . )
combinable with bar code and label technology.

Similarly, the use of daily light-exposed products such as printed goods, paper or film in the outdoor sector is by virtue of the fade-resistant coloration conceivable as an important use sector for the novel product. Conventional inkjet inks are all distinctly limited here.

The black to blue-black iron gall ink which, as its name implies, consists essentially of iron salt and gallic acid (tannic acid) is obtained for example by dissolving 23.4 g of tannin (tannic acid), 7.7 g of crystalline gallic acid, 30 g of green iron(II) sulfate crystals, 10 g of gum arabic, 7 g of crude hydrochloric acid and 1 g of ascorbic acid in 1 liter of water.

According to the invention, the metal complex and the polyphenol are separated and one of the two components, preferably the polyphenol, is bonded to the paper surface—the metal salt in solution serves as a reactive dye.

Practical implementation is by impregnating the material e.g. paper with a 0.1-20%, preferably 2-5% aqueous solution of the polyphenol preferably at its surface.

Possibilities here are preferably polyphenols or carboxylated or sulfonated or phosphorylated phenols, preferably tannin, gallic acid, ellagic acid, pyrocatechol, resorcinol, hydroquinone, trihydroxy-benzenes, salicylic acid, vanillic acid, dihydroxy-carboxylbenzenes, and also ethers and esters thereof, or natural extracts of tanning substances.

To suppress any weak yellow coloration in the case of paper for example, the whiteners customary in the paper industry, for example white pigment, clay, TiO₂ and the like, can be used to endow the paper with a radiant white by fluorescence.

Usually colorless binders are used to achieve a layering on the surface—preferably without reacting with the polyphenol (tannin, gallic acid, gallates, . . . ), or only binding it reversibly (e.g. PVP).

To keep the coating stable to yellowing, the addition of an acidic component, especially phosphoric acid is advantageous.

To avoid discolorations of the coated paper through oxidation and rearrangement of the polyphenols, including gallic acid in particular, which are present in the coating composition, especially in the presence of moisture or on long storage, it is advantageous to add suitable stabilizers to the coating composition.

Suitable stabilizers are for example molecules having two or more OH groups (e.g. PEG, sugar, glycosides, . . . ) or amides with —CO—NR— or —CO—NH— structures (PVP+copolymers, polyamides, oligomeric amides, any desired amides, including proteins e.g. gelatin, . . . ) but also polyvalent ions (e.g. Ca in Ca(OH)₂).

Tanning substances occur widely in the vegetable kingdom. They are in particular polyphenols (aromatic systems having multiple hydroxyl groups), which are usually derivable from gallic acid and are often in a condensed state with other phenols and sugars. Bluish black inks are formed on addition of iron salts to extracts of the bark from oak, spruce, larch, black alder, leaves and fruits of many sumac species (e.g. the Eurasian smoketree) and of black tea—synthetically to tannins, ellagic acid compounds, gallic acid and derivatives thereof and also to all phenolic compounds, especially those with adjacent hydroxyl groups. Phenols combine with iron(III) ions to form red (e.g. salicylic acid), yellow (e.g. vanillic acid) or violet complexes. The complexes with polyphenols are often blue-black and sparingly soluble. Compounds with individual or nonadjacent hydroxyl groups form weak complexes. A charged function such as carboxyl for example can replace a hydroxyl group (e.g. salicylic acid). Compounds with adjacent hydroxyl groups which are additionally sterically bridged form strongly iron-binding pigments—in the case of iron(III) an octahedron from 3-bidentate ligands for example.

To ensure printability by inkjet printing, the ink must be absolutely free of precipitation or cloudiness since this will clog the printhead perhaps even irreversibly. Stabilization can be achieved through complexing of 3-valent iron and/or by stabilizing the 2-valent more soluble form.

The reactive paper is preferably coated with a layer of polyphenol (e.g. 5% gallic acid) and a suitable binder e.g. starch. Color formation ideally takes place close to/at the surface—polyphenols deep in the paper are therefore of no use and increase costs. A thick or gellike preparation of the polyphenol layer prevents excessively deep penetration into the pores of the paper. Since polyphenols tend to oxidize and also polymerize and this leads to undesirable discoloration of the paper, the addition of polymerization and oxidation stabilizers (e.g. sulfites, ascorbic acid, . . . ) is sensible—and discoloration through reaction with the binder must also be considered.

However, the metal salt can also be applied to the paper matrix and the polyphenol can be applied subsequently using the inkjet printer.

Preferably, the paper is coated with gallic acid or a gallic acid salt, with a polyamide, preferably polyacrylamide, as color stabilizer, phosphoric acid (against yellowing).

Film formation preferably takes place on the paper and not in the paper.

The ink of the invention preferably consists of a 1-30% and preferably an approximately 5% solution of a reactive ferric iron salt. The ferric iron reacts immediately (within seconds) to form an intensively colored polyphenol complex with the reactive components in the paper. The use of iron(II) salts (an unavoidable form of iron in customary inks for pH and solubility reasons), by contrast, requires a secondary step of oxidation by atmospheric oxygen, and thereby unnecessarily delays color formation under real-life printing conditions—although a certain proportion of iron(II) compounds can be tolerated and effectuates a perhaps desired long-term weak intensification of the color through provision of an iron pool. However, iron(II) is less helpful in the short term, since the printing operation only requires a few seconds of moist reaction time and complexing and color generation has to take place within this time—in this short time iron(II) has to be oxidized almost completely to iron(III) to provide good color strength.

To ensure printability by inkjet printing, the ink must be absolutely free of precipitation or cloudiness since this will clog the printhead perhaps even irreversibly. Stabilization can be achieved through complexing of 3-valent iron.

Possible options are iron(III) sulfate, iron alums, iron ammonium(III) sulfate, iron gluconate and iron lactate, if need be buffered in the range of nonprecipitation of iron(III) salts (primarily iron hydroxides or FeO(OH)). For iron gluconate there are a multiplicity of analogs having similar properties—the advantage is the moderate pH which is not very stressful to the printhead. Alternatively, iron ammonium sulfates for example are stable but very acidic (pH usually around 1-3) alternatives. Attention must be paid here to the construction of the printhead. Suitable stabilizers for iron(III) complexes are for example molecules with one or more OH groups (e.g. glycerol, glycol, PEG, sugar, glycosides, . . . ) or amides with —CO—NR— or —CO—NH— structures (PVP+copolymers, polyamides, oligomeric amides, any desired amides, including proteins e.g. gelatin, . . . ) but also diverse ions. Strong complexing agents (phosphate, citrate, tartrate, EDTA, . . . ) disrupt the reaction with the polyphenols and reduce/prevent the colored complex forming.

Particularly suitable stabilizers are molecules capable of replacing water in the hydrate sheath without forming strong complexes that disrupt color formation.

Especially sulfates (cosmotropic ion) are particularly suitable here. Other cosmotropic ions such as phosphates or citrates usually have an excessively high binding affinity for iron, and thus disrupted color formation. Sulfates moreover have an extremely good water miscibility of 754 g/l—making it possible to produce aqueous solutions (actually more like systems) which are virtually free of “unbound” water. Thus, there is also scarcely any free water available for the hydrolysis of the iron(III) compounds and the ink system can be maintained at a reactively high pH in the inkjet cartridge (or in the tank) in the clouding-resistant state. Strongly hydrated anions (e.g. sulfate) here have the same effect as weakly hydrated cations (e.g. ammonium) and are referred to as cosmotropic.

Since, however, sulfates themselves are only weakly pH-active (buffer effect) and thus a mixture of 5% of iron(III) sulfate on addition of 0-20% of ammonium sulfate changes its pH of about 1.4 to just above pH 2, secondary ions of increased buffering effect (e.g. azeates) can also be added. In the process, the pH can be raised up to about pH=5 or higher without effectuating the precipitation of insoluble iron salts (iron hydroxides or the like) in the short term. pH values of up to 8 are achievable.

Organically stabilizing compounds are for example mono- or polyhydric alcohols such as butanol, glycerol, diglycerol, triglycerol, sugar, sugar alcohols, sugar acids, or hydroxy carboxylic acid.

To set the viscosity, the evaporation behavior and the flow behavior, it is usually organic solvents (e.g. Dowanol, glycerol, glycol and the like) and/or polymers e.g. gum arabic which are added.

The printing systems used according to the invention are inkjet printers (matrix printers) which through the targeted ejection or the deflection of small reactive droplets produce a printed image by chemical reaction with the surface coating. There are continuous inkjet printers and drop-on-demand printers, i.e. printers that eject individual droplets.

Continuous inkjet printers are only used in industry, in various sectors (e.g. scratch cards, best before date, EAN code, addressing, personalization, etc.). The inkjet emerges from the printhead via a nozzle. This jet is modulated via a piezoelectric transformer positioned behind the nozzle, so that a uniform disintegration into individual droplets is obtained, and electrostatically charged up. The droplets subsequently pass through a comparatively large deflection electrode where they are deflected sideways as a function of their specific electric charge.

Drop-on-demand ink printers are used in the small office and home sector as well as in industry. The appliances are additionally categorized according to the technique used to expel the droplets of ink. But electric circuits can also be constructed therewith to produce 3D models. Instead of ink it is also possible to use wax, long-chain polymers or hot, liquid solders. Bubble jet printers create miniscule droplets of ink by means of a heating element. Two systems are employed here: Lexmark and HP in the Deskjet range rely on flat nozzle elements. The process is very simple to produce and inexpensive, but has the disadvantage of a limited printhead life. Canon uses nozzles situated at a right angle to the heating elements in its printers (edge shooters). The individual heating element operates at a frequency up to 10 000 Hz. Piezo printers use piezo crystals to force printing ink through a fine nozzle. The ink forms droplets, the volume of which can be controlled via the applied electric pulse e.g. Epson and Siemens from 1977 on. Pusher valve printers had individual valves attached to the nozzles.

On-demand printers all have the property that the ink dries over time and/or clogs the nozzles. To prevent this, the inks are not very fast-drying—appropriate additions of usually comparatively high-boiling solvents up to about 30% are usually necessary. Most printers conduct a cleaning cycle. A further possibility is to park the printhead, so that little air gets to the nozzles. Depending on printer model and ink cartridge size, the cartridge can be empty after 40 to 100 cleans.

The ink used in ink (jet) printers is usually waterborne and admixed with additives. These prevent excessively fast drying and especially throughdrying in the nozzle.

Inkjet printers only perform to their capacity on specialty paper. With normal paper, the ink penetrates into the paper and spreads out therein to form a partly inhomogeneous spot which is significantly larger than the actual droplet of ink. The result is ill-defined boundaries—the inks which are reactive according to the invention are able to prevent or distinctly reduce this.

The disadvantages of existing ink printing processes compared with other processes are the sensitivity with regard to the medium to be printed, many inks are not archivable and fade appreciably faster than with other processes. The method of the invention makes it possible to print colored complexes which are indelible.

Some types of cartridges, for example the black cartridges from HP, are under reduced pressure and leak if not sealed air-tight after filling. Others, such as the colored cartridges from HP, are at atmospheric pressure on the inside and must not be sealed air-tight. Since iron(II) complexes are air-reactive in some instances, the use of air-tight cartridges is preferable.

The examples which follow describe the technical realization without limiting it:

### EXAMPLE 1

### Coating on Paper

Gallic acid is dissolved in water and mixed in a variable mixing ratio (typically up to 5% w/v) with a Blankophor whitener customary in the paper industry. A film former such as starch, polyvinylpyrrolidone, hydroxyethylcellulose, carboxymethylcellulose, polyvinyl alcohol, PVP-co-polyvinyl acetate, soluble polyamides, polyethyleneimine or comparable polymers is added followed by stirring until everything has dissolved. Stabilizers such as sodium sulfite or ascorbic acid are added if necessary. The mixture is applied in a coating machine (e.g. papermaker's machine with coating unit) to the carrier material e.g. paper in a thin layer. A glossily white surface is obtained on the paper.

After contact with an inkjet-applied iron solution a black script is formed.

### EXAMPLE 2

### Coating Variations

Construction as per example 1. The gallic acid is replaced by tannin, ellagic acid, gallic esters (especially those which are licensed for use in the food industry and characterized by E-numbers), tanning substance extracts of various plants or any desired other polyphenols or carboxyphenols (e.g. salicylic acid).

Contact with iron inkjet ink produces a script in different hues (e.g. red to violet with salicylic acid, yellow with vanillic acid, . . . ).

### EXAMPLE 3

### Tinting of Layers

Color pigments or whiteners (calcium carbonate, organic white pigments, titanium dioxide, clay) can be added to tint the material.

### EXAMPLE 4

### UV Protection

Pigments can exhibit yellowish or gray discolorations following exposure to light or heat. The reactive layer can therefore also be admixed with UV filters and other stabilizers—they prevent premature yellowing of papers. The filters used can be any filterpolymers and pigments known from photography or from sunscreens.

### EXAMPLE 5

### Inkjet Inks

A typical inkjet ink can be produced by dissolving 3-5% of iron gluconate in water. It is customary to add a nonvaporizable organic solvent in which the iron salt should be soluble (to protect the printhead against drying out such as sparingly volatile organic solvents e.g. glycerol, alcohol esters or ethers) and a stabilizer against clouding (usually a polymer such as gum arabic), especially when iron(II) salts which are prone to clouding by oxidation are used.

After complete solution, the ink is filtered and filled into the printheads.

### EXAMPLE 6

### Inkjet Inks—Variations

Other metal salts of iron, molybdenum, tungsten or titanium can be used similarly to example 5. What is important is the absolute stability of the solution since any clouding would lead to printhead destruction. Titanium is usually used as triethanolamine complex or lactate, molybdenum and tungsten as molybdates or tungstates e.g. sodium molybdate, sodium phosphomolybdate, sodium tungstate.

Suitable iron compounds are for example iron(II) sulfate, ammonium iron sulfate, iron lactate, iron gluconate. Strong complexing agents (phosphate, citrate, EDTA, . . . ) disrupt the reaction with the polyphenols and reduce/prevent the colored complex forming.

### EXAMPLE 7

### Iron(III)-Based Inkjet Ink

A typical inkjet ink can be prepared by dissolving
5% of iron(III) sulfate,
5% of ammonium sulfate,
0-10% of ammonium acetate (to set the pH),
10% of glycerol,
0-5% of detergent
   in water.

The pH of the solution varies from pH˜1.5 (without addition of ammonium acetate) to about pH=5, and can be varied via the ammonium acetate content. The storage stability of the solution slightly decreases with higher pH—but compatibility with existing printheads increases. The pH is, accordingly adapted according to which printhead technology is used. However, printheads from large manufacturers also do exhibit some long-term compatibility at below pH 2.0.

Small amounts of insoluble iron(III) precipitates formed can be kept in colloidal solution by a stabilizer against cloudiness (usually a polymer). After complete solution the ink is filtered and filled into the printheads.

### EXAMPLE 8

### Acidic Iron(III)-Based Inkjet Ink

An acidic inkjet ink can be prepared by dissolving
5% of iron sulfate,
20% of ammonium sulfate,
10% of glycerol,
0-5% of detergent
   in water.

The pH of the solution is about 2.1. The storage stability of the solution is excellent and the solution is compatible with standard printheads.

### EXAMPLE 9

### Technical Grade Iron(III)-Based Inkjet Ink

An acidic inkjet ink can be prepared by diluting an approximately Ferral solution (approximately 30% technical grade iron(III) aluminum sulfate chloride for wastewater technology) in a ratio of 1+5 with a solution of
10% of ammonium sulfate,
10% of glycerol,
0-5% of detergent
   in water.

The pH of the solution is <2. Technical grade solutions may have to be filtered before filling to remove all particles>100 μm, since these can damage printheads.

### EXAMPLE 10

### Storage Stability

### Ink:

| | |
|---|---|
| 5% of Fe(III)SO₄ | Color agent |
| 5% of ammonium sulfate | Complexing agent |
| 5% of ammonium acetate | Buffer |
| 1% of Tween | Detergent |
| 10% of glycerol | Moisturizing agent |

After one year's storage, the ink was stable, without flocking, and did not shown any fungal growth.

1. A reactive inkjet printing method for practice on substrates such as paper, paperboard, corrugated fiberboards, film, injection- or compression-molded plastics parts, metal, ceramic surfaces, paint layers or corrosion control layers, characterized in that the substrates are coated with a polyphenol and a reactive ink consisting of at least one dissolved metal salt selected from the group of compounds of iron, molybdenum, tungsten, copper and titanium is made to react on or in the surface of said substrates by inkjet printing to form a colored complex that is stable and immediately perceivable by the human eye.

2. The method as claimed in claim 1, characterized in that the substrates have been coated with di- and trihydroxyphenols, or carboxylated, sulfonated or phosphorylated phenols or derivatives thereof or mixtures thereof.

3. The method as claimed in claim 1, characterized in that the colored complex formed is indelible.

4. The method as claimed in claim 1, characterized in that drop-on-demand or continuous inkjet printers are used as the printing system.

5. The method as claimed in claim 1, characterized in that the construction change perceivable by the human eye is additionally finalized/fixed by thermal or electromagnetic radiation, a chemical agent or by mechanical treatment.

6. The method as claimed in claim 1, characterized in that the color changes is effected by generation of chromophoric compounds of metal from preferably colorless and/or weakly colored metal salts of iron, copper, molybdenum, tungsten or titanium.

7. The method as claimed in claim 1, characterized in that at least some of the color changes are effected by chemical reaction of iron salt solutions with gallic acid- or gallic ester-coated materials based on paper/cellulose.

8. The method as claimed in claim 1, characterized in that at least some of the color changes are effected by chemical reaction of surface-applied or surface-incorporated polyphenols or carboxylated phenols, preferably tannin, gallic acid, ellagic acid, pyrocatechol, resorcinol, hydroquinone, trihydroxybenzenes, salicylic acid, vanillic acid, dihydroxycarboxylbenzenes, and also ethers and esters thereof, or natural extracts of tanning substances are used.

9. The method as claimed in claim 1, characterized in that the reactive layers are applied by print-, paint- or paper-engineering methods such as blade coating, spraying, dip coating or common printing methods, such as gravure, flexographic, screen, offset or digital printing, curtain coating or roll application methods with co- or counter-rotating rolls.

10. The method as claimed in claim 1, characterized in that the method is reversed in that aqueous and/or organic solutions of polyphenols or carboxylated phenols are used as inkjet ink and the reactive metal salts are applied as coating and the color becomes visible immediately after the reactive printing.

11. The method as claimed in claim 1, characterized in that iron is used to produce black, blue, yellow, brown and reddish colors depending on the polyphenol.

12. The method as claimed in claim 1, characterized in that copper is used to produce green and blue colors depending on the polyphenol.

13. The method as claimed in claim 1, characterized in that molybdate and tungstate are used to produce yellow and brown colors depending on the polyphenol.

14. The method as claimed in claim 1, characterized in that titanate is used to produce yellow colors with polyphenol.

15. The method as claimed in claim 1, characterized in that the iron salt solution has a pH below 8 preferably below 6 and contains weakly complexing additions which maintains the iron salt hazelessly in solution preferably ammonium, amides, polyamides, polyhydroxy compounds such as gluconic acid or hydroxyacids such as lactic acid, and does not contain strong iron-complexing agents such as for example EDTA or citric acid in a comparatively high, substantially iron-binding concentration.

16. A coated product for use in a method as claimed in claim 1, characterized in that paper, paperboard, corrugated fiberboards, film, injection- or compression-molded plastics parts, metal, ceramic surfaces, paint layers or corrosion control layers are coated with reactive receiving layers comprising polyphenols or carboxylated phenols.

17. The coated product as claimed in claim 16, characterized in that the reactive receiving layers comprising polyphenols or carboxylated phenols contain stabilizers, preferably pH stabilizers, reductants and polymerization inhibitors to suppress graying or browning especially on exposure to wet-moist heat.

18. A writing system for inscription of coated surfaces as claimed in claim 16, characterized in that the reactive ink in the stock reservoir container of the printer consists of a solution of the compounds mentioned in claim 4 and any necessary addition agents against drying out of nozzles and any stabilizers of the metal salt.

19. The method as claimed in claim 1, characterized in that the metal salt solution and the polyphenol solution are applied to the substrate to be inscripted in succession or simultaneously in one printing operation.

20. A reactive inkjet printer ink for an inkjet printing method for performance on substrates such as paper, paperboard, corrugated fiberboards, film, injection- or compression-molded plastics parts, metal, ceramic surfaces, paint layers or corrosion control layers that have been coated with a polyphenol, characterized in that the reactive ink consists of a molecular or colloidal solution of 1% to 30% by weight of a dissolved iron(III) salt and has a pH up to 8.

21. The reactive inkjet printer ink as claimed in claim 20, characterized in that the particle size in the solution is <100 μm.

22. The reactive inkjet printer ink as claimed in claim 20, characterized in that made to react at or in the surface of a polyphenol-coated substrate it forms an indelible colored complex that is stable and immediately perceivable by the human eye.

23. The reactive inkjet printer ink as claimed in claim 20, characterized in that the iron(III) or iron(II) salt solution contains weakly complexing additions which maintains the iron salt hazelessly in solution preferably ammonium salts, sulfates or sulfonic acids, organic acids and their salts, amides, soluble polyamides and also polyhydroxy compounds such as sugars or polyols.

24. The reactive inkjet printer ink as claimed in claim 20, characterized in that the iron(III) salt solution contains 1-10% of iron(III) salt, 0-20% of a soluble sulfate, 0-10% of acetates to set the pH, 0-30% of an organic solvent as moisturizing agent, of a polyhydroxy compound for viscosity adjustment, and 0-5% of detergent.

25. The reactive inkjet printer ink as claimed in claim 20, characterized in that it contains 1-10% of iron(III) sulfate or iron(III) chloride or iron aluminum sulfates/iron aluminum sulfate chloride mixtures.

26. The reactive inkjet printer ink as claimed in claim 20, characterized in that this iron(III) salt solution contains 1-10% of iron(III) salt, 0-20% of alkali metal or ammonium sulfates and 0-10% of alkali metal or ammonium acetates to set the pH.

27. The reactive inkjet printer ink as claimed in claim 20, characterized in that it contains 5% of iron(III) sulfate, 5% of ammonium or alkali metal sulfate, 0-10% of ammonium or alkali metal acetate, up to 20% of glycerol and 0-5% of an iron-compatible detergent.

28. The reactive inkjet printer ink as claimed in claim 20, characterized in that the iron(III) salt is partly or wholly replaced by iron(II) salt, and the iron(II) salt is partially or completely converted into the iron(III) salt by access of atmospheric oxygen or by oxidizing agents.

29. The reactive inkjet printer ink as claimed in claim 20, characterized in that the reactive ink is marketed, stored and/or used in the stock reservoir container of the printer, of the printer tank or in refill bottles.

30. Printer tanks or ink refill bottles, characterized in that these are filled with a reactive inkjet printer ink as claimed in claim 20.
